(19) United States
(12) Patent Application Publication
(10) Pub. No.: US 2008/0210152 A1
(43) Pub. Date: Sep. 4, 2008

(54) Open Life Indicator Label for Food Produce and Suchlike

(76) Inventors: John Robinson, Lancashire (GB); Stephen Wintersgill, Lancashire (GB); Long Lin, Leeds (GB); Alexander Roy McLennan, Cheshire (GB)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/814,466

(22) PCT Filed: Jan. 20, 2006
(86) PCT No.: PCT/GB2006/000190

§ 371 Date: Mar. 14, 2008

(30) Foreign Application Priority Data
Jan. 21, 2005 (GB) 0501304.0
Dec. 24, 2005 (GB) 0526451.0

(51) Int. Cl. G04F 1/00

(52) U.S. Cl. 116/206; 368/327

(57) ABSTRACT

A time indicator label comprises a backing layer, an active layer and a barrier layer. Removal of said barrier layer activates said time indicator label.

The present invention is in the field of time dependent labelling, more specifically in time dependent indicator labels suitable for use on food and other products.

The foregoing invention will be described with reference to its use on food products, however it is recognised and will be readily apparent that the invention could also find application in other fields such as pharmaceutical products, cosmetics and any other products which have a limited open life.

It is common with food products, especially those in jars, to provide a “best before” date, after which the product should not be used; however, this date is only a reliable measure if the primary packaging is in an unopened state. It is becoming increasingly common for a second date to be provided on external packaging, a “Once opened, use within” date, which is an attempt to reflect the accelerated decay of the produce following breach of the primary packaging. Whilst the use of a “Once opened, use within” date is an advance on the previous state of the art, it relies on the consumer remembering when a product was first opened. This is fine when the open life is short (e.g. 3 days for orange juice); however, some products have an open life of several weeks or even months, at which point the consumer's memory becomes an unreliable measure, with people tending to rely on the smell of the product or assuming it will be alright and using it anyway. This is unsatisfactory both for the consumer, who will get poor performance from the product, and may suffer an upset stomach or other complaint as a result of eating tainted food, and also for the manufacturer, who will probably lose a future customer, due to their dissatisfaction with the product.

Clearly there is a need, both from the manufacturers' and the consumers' perspective, for a simple, inexpensive and reliable indicator for such produce containers in order to better safeguard the consumers' health and also to improve customer perception of manufacturers.

A number of means to accomplish this objective have been attempted in the past and are known in the art; however, all have their drawbacks which are to be addressed by the present invention. These previous attempts will be discussed briefly forthwith.

U.S. Pat. No. 4,292,916 BRADLEY describes a timer and storage condition indicator, utilising a physical and/or chemical interaction between two layers of a label. Reactive chemicals migrate through a porous layer into a soluble ink, thereby revealing an expiry message.

U.S. Pat. No. 5,053,339 PATEL describes diffusion of a reactive/coloured agent through a porous/permeable matrix presenting a colour change in a viewing area. This allows time/temperature observation over a period of time as the colour on view increases in intensity.

U.S. Pat. No. 5,633,835 and U.S. Pat. No. 5,446,705 (both to) HAAS describe a longer term solution, whereby migration between two layer of a label is prevented by a barrier layer, the barrier layer being soluble. Upon dissolution/breach of the barrier layer the colour change brought about by contact between the reactive layers is substantially instantaneous.

WO 03/007088 ISBITSKY works along similar lines, but initiation is by a consumer. Initiation involves the consumer applying pressure directly to a portion of an indicator label in order to rupture a reactant reservoir or force the reactant from a storage reservoir into a second reservoir, which is in direct contact with a porous migration medium. Once in the second reservoir the reactant migrates at a predetermined rate along the migration medium, with a colour change being observed along its length.

U.S. Pat. No. 6,741,523 BOMMARITO describes a user activated, time dependent labelling system. The user activates the system by physically puncturing/fracturing a fluid reservoir, the fluid then flows along channels defined in a “microstructured substrate” at a pre-determined rate, the passage of said fluid being observed either by virtue of said fluid being coloured or said substrate having specific retro-reflective properties.

In the case of the PATEL and HAAS documents, the timer is started upon manufacture or application of the label, whereas the BRADLEY document, while covering this possibility, also allows for user initiation. The ISBITSKY, BOMMARITO and some embodiments of the BRADLEY devices rely on a consumer having a direct and conscious input into the working of the timer. Both of these systems have inherent problems, the PATEL and HAAS devices are fine as USE BY indicators, but due to their initiation at manufacture can take no account of the accelerated rate of produce decay upon breach of primary packaging exposing the produce to bacteria and suchlike present in the atmosphere. Equally the user activated devices described in BOMMARITO, BRADLEY and ISBITSKY rely on a consumer remembering to activate the device upon opening their produce, this is easily forgotten and could leave unaffected exactly the problems they are intended to address.

A few attempts have been made to address the aforementioned shortcomings of the above products. WO 01/26993 KAGAN and GB 2,344,101 TAYLOR both describe time indicating closures for containers. Both documents describe ostensibly the same system, whereby a reservoir is breached by the act of opening the closure/lid of a container holding the perishable produce. In both cases there is a multi-component lid with various moving parts designed to puncture a reservoir containing a reactive compound. Both of these devices borrow heavily from known art in the field of tamper evidence (such as WO 99/24329 TYLDESLEY) and suffer from the same main drawback, which is that a multi-component lid/closure is difficult to manufacture and assemble and therefore too costly to gain mainstream commercial acceptance.

The terms capillary/capillaries/“capillary member(s)” as used herein are not intended to be restricted to whole tubes of circular cross section, rather they refer to any tube(s) or channel(s), open or enclosed, which is/are of appropriate dimension and construction to exhibit capillary action on one or more solvents by virtue of the inter-relation of their respective surface tension characteristics.

The term solvent is not intended to be restricted merely to classical organic solvents, rather should be interpreted to mean any liquid or blend of liquids within which a second substance (in this instance the dye) could be dissolved. Hence water would be classed as a solvent, which is typically not the case within many industries (e.g. printing).

The label of a first aspect of the present invention works along the following principle. Immediately following activation, a solvent tracks along one or more capillaries from a solvent reservoir to a dye store, the dye then dissolves into the solvent and diffuses back to the solvent reservoir. The solvent reservoir is provided with a viewing window such that the colour change can be readily observed.

Various factors effect the rate at which the solvent tracks along the capillaries (Capillary Tracking Time, CTT) and also the rate at which the dye both dissolves and diffuses back along the capillaries (Dye Diffusion Time, DDT):
The surface tension of the solvent
The viscosity of the solvent
The surface tension of the substrate from which the capillaries are formed
The dimensions of the capillary (depth, width, length)
The shape of the capillary
The solubility of the dye

Whilst a number of these factors effect both the rate at which the solvent tracks along the capillaries and also the rate at which the dye dissolves and diffuses back along the capillaries, the choice of substrate and also capillary size and shape have a considerably greater effect on the CCT than the DDT. Adjustment of these factors allows a large degree of control over both CCT and DDT within a single set of capillaries and also allow easy provision of two or more sets of capillaries which present different total times (CCT+DDT) for discolouration to occur. Thus it can be seen that it would be easy to provide a label giving a first discolouration after a first pre-determined time, followed by a second discolouration after a further interval.

The advantage of a system such as this is that, using the non-limiting example of such a label applied to a jar of mayonnaise, upon opening the jar, the label is activated, a green underprint is visible through the solvent reservoir, informing the consumer that the mayonnaise is good to use, after a first predetermined time, a first dye discolours the solvent to an amber colour (covering the green print) informing the consumer that the mayonnaise is nearing the end of it's usable life, and that caution should be exercised and consideration given to purchasing a replacement jar. After a further, pre-determined interval, a second dye overpowers the first dye and discolours the solvent to a strong red colour, informing the consumer that the mayonnaise is no longer safe to use and should be discarded. The amber warning period gives the consumer notice that the product is approaching the end of its useful life, thereby allowing them to avoid the embarrassment of running out of essential products on the night of a dinner party for example.

According to a first aspect of the present invention, there is provided a time indicator label comprising a backing layer, an active layer and a barrier layer, characterised in that removal of at least a portion of said barrier layer activates said time indicator label.

Preferably said backing layer is further provided with an adhesive on the side opposite to the active layer, such that it can be easily attached to a container or other receptacle.

Preferably said backing layer is further characterised in that it has, defined thereon, at least one solvent reservoir portion and at least one dye store portion, said solvent reservoir and dye store portions being interconnected via at least one capillary member.

Said one or more solvent reservoir portions, one or more dye store portions and one or more capillary members may be defined via embossing, printing, etching or any other technique.

Preferably said active layer comprises at least one solvent and at least one dye, said solvent(s) and said dye(s) being applied to said solvent reservoir portion(s) and dye store portion(s) respectively, said solvent and dye optionally being entrained within an adhesive. Said solvent(s) and said dye(s) are preferably applied via a printing process.

Preferably said backing layer comprises a single solvent reservoir portion and two or more dye store portions, each dye store portion preferably being connected to said solvent reservoir portion via one or more capillary members, such that each dye store portion has a dedicated set of one or more capillary members connecting it to said solvent reservoir portion, the dye store portions having two or more different coloured dyes applied thereto.

Preferably said solvent is a so-called green solvent such as glycerol or diethylene glycol.

Preferably said solvent has a sufficient degree of temperature sensitivity to confer time-temperature indication characteristics upon the label.

Preferably said barrier layer covers said one or more solvent reservoir portions, said one or more dye store portions and said one or more capillary members.

Preferably the barrier layer comprises one or more removable portions which block one or more of said capillary members in one or more areas, whereby removal of said removable portion(s) has the effect of unblocking said one or more capillaries.

Preferably said one or more removable portions of said barrier layer are removed automatically upon opening of whatever container the label has been applied to, preferably said automatic removal is achieved by attaching part of said one or more removable portions to the lid of said container, such that removal of said lid causes removal of said one or more removable portions.

Optionally said barrier layer is translucent over the majority of its area, with a windowed area being provided for observation, said windowed area preferably being over the solvent reservoir portion, this may be achieved by overlaying a further windowed substrate onto a transparent barrier layer or by manipulation of the material properties of the barrier layer, such as selective chemical vapour deposition of aluminium.

Said backing layer may be printed over some or all of its surface area, preferably said printed area corresponds to said solvent reservoir portion.

According to a second aspect of the present invention, there is provided a time indicator label comprising a backing layer, an active layer and a barrier layer, characterised in that removal of said barrier layer activates said time indicator label, said backing layer comprising a solvent reservoir portion, a first set of one or more capillary members connecting said solvent reservoir portion to a first dye store portion, a second set of one or more capillary members connecting said solvent reservoir portion to a second dye store portion, said active layer comprising a solvent, a first dye and a second dye, said solvent, first dye and second dye being respectively applied within said solvent reservoir, first dye store and second dye store portions; said barrier layer being applied over the solvent reservoir portion, dye store portions and capillary members, said barrier layer further comprising removable portions, said removable portions being located adjacent said solvent reservoir and dye stores and being applied over the capillary members in such a manner as to block said capillaries in these pre-defined areas, said barrier layer being further provided with window means such that the solvent reservoir portion is visible.

According to a third aspect of the present invention, there is provided a time indicator label for a perishable goods container, said label comprising a backing layer, a reactive layer, a diffusion layer and a barrier layer, characterised in that said barrier layer is removed automatically from said label upon opening of said container, removal of said barrier layer activating said time indicator label.

The reactive layer preferably changes colour over time in response to one or more external stimuli, the rate of change preferably being related to said one or more external stimuli.

The reactive layer may comprise several components which exhibit colour change after differing periods of time, possibly providing a traffic light style indication.

The reactive layer is preferably oxygen reactive.

Preferably the reactive layer is formed by bringing two none oxygen reactive components into intimate contact, said two components reacting with each other to form an oxygen reactive component.

Preferably one or both of the barrier layer and the backing layer comprise an oxygen barrier layer, and preferably formed from aluminium foil, an aluminium foil/film laminate or a metallised plastic film.

Preferably one or both of the barrier layer and the backing layer extend beyond the peripheries of the reactive layer.

Preferably the diffusion layer comprises a plastic film, preferably a film with good oxygen barrier properties such as nylon or PET.

The diffusion layer may further comprise indicia to provide a ready comparison with the colour of the reactive layer.

The reactive layer may be a multi component layer, said components reacting with each other following exposure to one or more external stimuli. Said multi component reactive layer may be a photo-initiated reactive layer.

The barrier layer may be a light barrier.

The invention will be better understood with reference to the foregoing embodiments, which are given merely by way of example and are in no way intended to limit the scope of the present invention.

FIG. 1 shows a top view of the backing layer of a label according to one embodiment of the present invention.

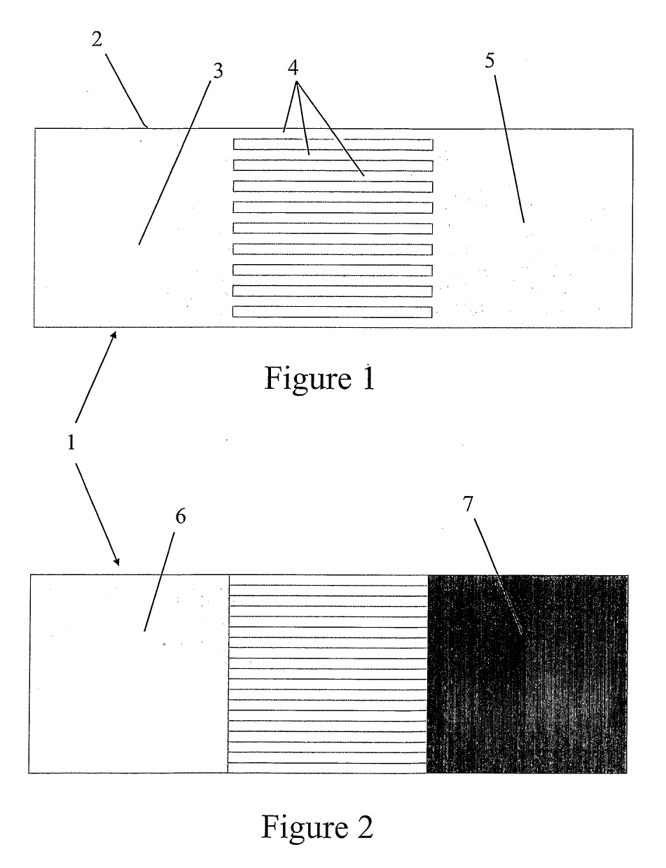

FIG. 2 shows the same backing layer after both solvent and dye have been applied thereto.

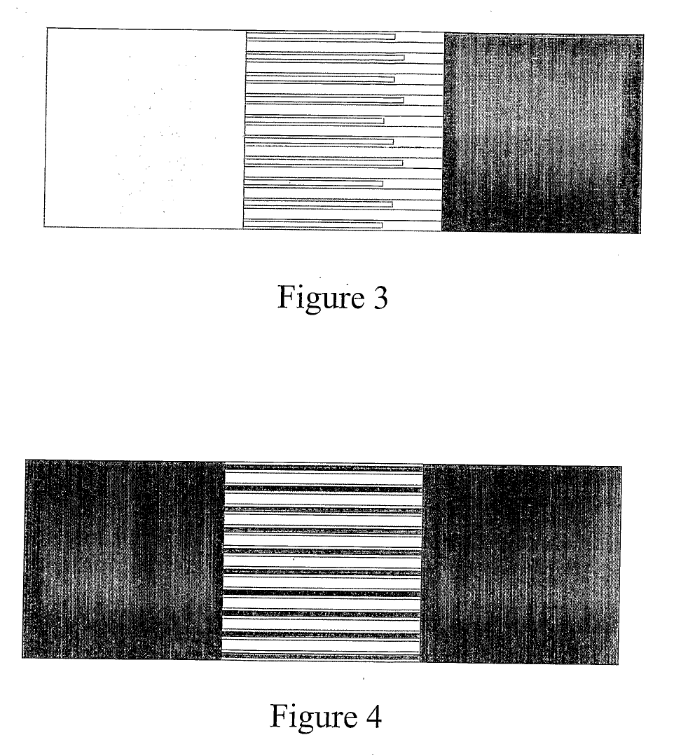

FIG. 3 shows the same backing layer/solvent/dye combination after activation, but before the solvent has reached the dye.

FIG. 4 shows the same combination after the dye has diffused back through the capillaries and discoloured the solvent reservoir.

A first embodiment describes a label according to the current invention in its simplest possible terms, this is intended to clarify the manner in which the label operates rather than the most likely form in which it would be used.

A label 1 comprises a backing layer 2 of polypropylene extrusion coated onto an aluminium foil substrate. The backing layer 2 has been embossed with a solvent reservoir portion 3, a series of capillaries 4 and a dye store portion 5. A solvent 6 is applied to the solvent reservoir portion 3 and a dye 7 is applied to the dye store portion 5, immediately following which a barrier layer (not shown) is laminated over the entire area of the backing layer, the method of lamination being such that the barrier layer blocks the capillaries 4 at either end, i.e. immediately adjacent both the solvent 6 and the dye 7. The barrier layer has a viewing window located over the solvent reservoir 3, but is otherwise translucent. The barrier layer comprises two frangible portions, where it blocks the capillaries 4, said frangible portions both being attached to a “pull tab”. Upon pulling the “pull tab” the frangible portions are removed thereby unblocking the capillaries 4, at this point the solvent begins to be drawn up the capillaries by the process of capillary action, although with the solvent 6 being colourless and the capillaries 4 being obscured by the barrier layer there is no visible effect. After a predetermined time (henceforth referred to as the Capillary Tracking Time or CTT) the solvent 6 reaches the dye 7, at this point the dye 7 begins to dissolve into the solvent 6 and diffuse back along the capillaries 4, although again there is no visible effect due to the barrier layer obscuring the dye store 5 and the capillaries 4. After a further pre-determined time (henceforth referred to as the Dye Diffusion Time or DDT) the dye 7 diffuses back along the entire length of the capillaries 4 and discolours the solvent remaining in the solvent reservoir 3. At this point the label gives a visible indication, since a user can observe the discolouration of the solvent reservoir 3 through the windowed portion of the barrier layer.

According to a second embodiment, a label comprises a backing layer of polypropylene extrusion coated onto an aluminium foil substrate. The backing layer has been embossed with a solvent reservoir portion, a first series of capillaries leading to a first dye store portion and a second set of capillaries leading to a second dye store portion. Further to this, a coloured print is laid down on the solvent reservoir portion. A solvent is applied to the solvent reservoir portion, a first coloured dye is applied to the first dye store portion and a second coloured dye is applied to the second dye store portion, immediately following which a barrier layer (not shown) is laminated over the entire area of the backing layer, the method of lamination being such that the barrier layer blocks both sets of capillaries at either end, i.e. immediately adjacent both the solvent and the first and second dyes. The barrier layer has a viewing window located over the solvent reservoir, allowing the coloured print to be seen, but is otherwise translucent. The barrier layer comprises a plurality of frangible portions, where it blocks the capillaries, said frangible portions being attached to a “pull tab”. Upon pulling the “pull tab” the frangible portions are removed thereby unblocking the capillaries, at this point the solvent begins to be drawn up both sets of capillaries by the process of capillary action, although with the solvent being colourless and the capillaries being obscured by the barrier layer there is no visible effect. After a pre-determined time (henceforth referred to as the Capillary Tracking Time or CTT) the solvent reaches the first dye, at this point the first dye begins to dissolve into the solvent and diffuse back along the first set of capillaries, although again there is no visible effect due to the barrier layer obscuring the dye store 5 and the capillaries 4. After a further pre-determined time (henceforth referred to as the Dye Diffusion Time or DDT) the first dye diffuses back along the entire length of the first set of capillaries and discolours the solvent remaining in the solvent reservoir. At this point the label gives a visible indication, since a user can observe the discolouration of the solvent reservoir through the windowed portion of the barrier layer. At the same time as solvent begins to be drawn up the first set of capillaries, solvent is also drawn up the second set of capillaries, reaching the second dye at a second pre-determined time, the second dye then dissolves and diffuses back along the second set of capillaries, arriving at the solvent reservoir after a further, second DDT. If the second dye is a stronger colour than the first dye, and the first dye is a stronger colour than the initial print laid down then a traffic light effect can be obtained. For example, if the initial print is pale green, the first dye is orange and the second dye is a strong red colour then the following series of events occurs after activation. Initially, the green print is visible through the transparent portion of the barrier layer, after the first CCT and DDT expire, the orange dye discolours the solvent reservoir, presenting a visible amber signal, after the second CCT and DDT expire, the red dye discolours the (already discoloured) solvent reservoir, presenting a vivid red signal.

According to a third embodiment label for a perishable goods container comprises a backing layer of foil, laminated onto a plastic film. A first component, A, of a reactive layer being printed onto the foil portion of the backing layer. A barrier layer of foil laminated onto a plastic film is peelably adhered to a diffusion later of PET, onto which is printed a second component, B, of a reactive layer. The label is assembled by the permanent adhesion of the backing layer onto barrier layer, thereby producing a laminate comprising a foil/film laminate backing layer, a reactive layer comprising components A and B, which react on contact to form oxygen reactive component C, a PET diffusion layer and a foil/film laminate barrier layer. Oxygen is effectively excluded from the reactive layer by the presence of the backing layer and the barrier layer, hence component C remains in its non-reacted state.

In use, the label is adhered permanently, via the backing layer, to a food container, a string adhesive is applied to the outside of the barrier layer and the container is then shrink wrapped, the shrink wrap thus becoming permanently adhered to the external surface of the barrier layer.

When the product is opened in the consumer's home, the first action is to remove the shrink wrap, which action also removes the barrier layer from the indicator label. At this point, oxygen begins to diffuse through the diffusion layer at a predetermined rate, said rate being dependent upon the grade of polymer used for the diffusion layer, the thickness of the diffusion layer and the temperature at which the label is stored. After a predetermined period of time, sufficient oxygen will have diffused through to the reactive layer to have completely reacted with component C, at which point the colour change thereby induced will be readily apparent.

According to a fourth embodiment, the construction of the label is ostensibly the same, however, rather than the barrier layer being removed by the removal of a shrink wrap (which not all products are supplied with), the backing layer is adhered to a tamper evident band which extends across the lid of the container. Upon opening of the container (and hence removal of the lid), the barrier layer is peeled off by virtue of the fact that it is adhered to the tamper evident strip which comes off integrally with the lid, thus the countdown begins upon opening of the container.

According to a fifth embodiment of the present invention, the reactive layer comprises two mutually reactive compounds A and B, A and B reacting to form compound C, there being a distinct colour difference between compounds A and B when compared to compound C. The reaction between compound A and B is photo-initiated, thus the barrier layer, being a foil laminate, effectively prevents initiation of said reaction by excluding light from the reactive layer.

In a final embodiment, the reactive layer comprises several discrete oxygen reactive components X, Y and Z, each having a different rate of reaction with oxygen. X, Y and Z being respectively formed by bringing compounds A & B, C & D and E & F into contact during assembly of the label. The mixtures of compounds A to F are all colourless, whereas compounds X, Y and Z are yellow, orange and red respectively. The backing layer has an inert green coloration, said green colour being a coating applied to the foil of the backing layer prior to label assembly. When the container is opened and the barrier layer removed, a green colour is visible on the label. After a period of three days, compound X has been totally oxidised, thus a yellow colour is visible on the label. After a further two days, compound Y has totally reacted, revealing an orange colour on the label. A further two days after this, compound Z finishes its reaction, presenting a red colouration, thereby informing the consumer that the product is no longer safe to consume.

1. A time indicator label comprises a backing layer having at least one solvent reservoir and at least one dye store portion defined thereon, an active layer comprising at least one solvent applied to the at least one solvent reservoir and at least one dye applied to the at least one dye store, and a barrier layer removal of at least a portion of which activates the active layer, wherein the at least one solvent reservoir and the at least one dye store portion are interconnected via at least one capillary member and wherein the at least one reservoir, dye store portion and capillary member are each formed by one of the techniques selected from the group comprising embossing, printing or etching.

2. A time indicator label according to claim 1, wherein said backing layer is further provided with an adhesive on a side opposite to the active layer, such that it can be attached to a container or other receptacle.

3-35. (canceled)

36. A time indicator label according to claim 1, wherein said solvent(s) and/or said dye(s) are entrained within an adhesive.

37. A time indicator according to claim 1, wherein said solvent(s) and/or said dye(s) are applied via a printing process.

38. A time indicator label according to claim 1, characterized in that said backing layer comprises a single solvent reservoir and two or more dye store portions.

39. A time indicator label according to claim 38, wherein each of said dye store portions is connected to the solvent reservoir via one or more capillary members, such that each dye store portion has a dedicated set of one or more capillary members connecting it to said solvent reservoir, the dye store portions having different colored dyes applied thereto.

40. A time indicator label according to claim 1, wherein said solvent is a green solvent such as glycerol or diethylene glycol.

41. A time indicator label according to claim 1, wherein said solvent has a sufficient degree of temperature sensitivity to confer time temperature indication characteristics upon the label.

42. A label according to claim 1, wherein said barrier layer covers the at least one solvent reservoir, the at least one dye store portion and said at least one capillary member.

43. A label according to claim 1, wherein said barrier layer comprises one or more removable portion which block the at least one capillary member in one or more areas, whereby removal of said removable portion(s) has the effect of unblocking the at least one capillary member, thereby activating the active layer by allowing the dye and/or solvent to flow from the respective dye store portion and reservoir into the at least one capillary members.

44. A label according to claim 43, wherein the one or more removable portions of said barrier layer are configured so as to be removed automatically upon opening of a container to which the label is applied.

45. A label according to claim 44, wherein the one or more removable portions is configured such that part of the one or more removable portions is attachable, in use, to a lid of the container, such that removal of a lid causes removal of said one or more removable portions.

46. A label according to claim 1, wherein said barrier layer is translucent over the majority of its area, with at least one windowed area being provided for observation.

47. A label according to claim 46, wherein the at least one windowed area is positioned over the at least one solvent reservoir.

48. A label according to claim 46, wherein the windowed area is formed either by overlaying a windowed substrate on to a transparent barrier layer or by manipulation of the material properties of the barrier layer.

49. A label according to claim 48, wherein the manipulation is by selective chemical vapour deposition of aluminum.

50. A time indicator label comprising a backing layer having a solvent reservoir and two or more dye store portion defined thereon, an active layer comprising at least one solvent applied to the solvent reservoir and at least one dye applied to each of the dye stores, and a barrier layer removal of at least a portion of which activates the active layer, wherein each of the dye store portions is connected to the reservoir via one or more capillary members, such that each dye store portion has a dedicated one or more capillary members connecting it to the reservoir, the dye store portions having different colored dyes applied thereto.

51. A time indicator label comprises a backing layer, an active layer and a barrier layer, characterized in that removal of said barrier layer activates active layer, said backing layer comprising a solvent reservoir portion, one or more first capillary members connecting said solvent reservoir portion to a first dye store portion, one or more second capillary members connecting said solvent reservoir portion to a second dye store portion, said active layer comprising a solvent, a first dye and a second dye, said solvent, first dye and second dye being respectively
